(19) United States
(12) Patent Application Publication
(10) Pub. No.: US 2018/0236488 A1
(43) Pub. Date: Aug. 23, 2018

(54) VIBRATION MOTOR

(71) Applicant: Nidec Seimitsu Corporation, Ueda-shi (JP)

(72) Inventor: Masahiko MIYAZAKI, Ueda-shi (JP)

(21) Appl. No.: 15/899,536

(22) Filed: Feb. 20, 2018

(30) Foreign Application Priority Data
Feb. 22, 2017 (JP) 2017-031301

(51) Int. Cl. B06B 1/04; H02K 33/02; H02K 33/16

(52) U.S. Cl. CPC B06B 1/045; H02K 33/16; H02K 33/02

(57) ABSTRACT

A vibration motor includes a stationary portion, a vibrating body, and an elastic member. The stationary portion includes a casing and a coil unit. The vibrating body includes a first weight portion, a second weight portion, and a magnet portion. The vibrating body is supported such that the vibrating body can vibrate in a lateral direction relative to the stationary portion. The elastic member is positioned between the stationary portion and the vibrating body. The length of the magnet portion in the lateral direction is smaller than a spacing between the first and second weight portions in the lateral direction. Gaps are provided between the first weight portion and a first magnet and between the second weight portion and a second magnet. The length of a coil member in the lateral direction is smaller than the length of the magnet portion in the lateral direction.

### CROSS REFERENCE TO RELATED APPLICATIONS

This application claims the benefit of priority to Japanese Patent Application No. 2017-031301 filed on Feb. 22, 2017. The entire contents of this application are hereby incorporated herein by reference.

### BACKGROUND OF THE INVENTION

### 1. Field of the Invention

The present invention relates to a vibration motor.

### 2. Description of the Related Art

There are related-art vibration motors provided in various devices such as smartphones. These vibration motors include so-called lateral linear-type vibration motors in which a vibrating body vibrates in the lateral direction. An example of such related-art vibration motors is disclosed in Chinese Unexamined Patent Application Publication No. 105518983.

The vibration motor of Chinese Unexamined Patent Application Publication No. 105518983 includes a casing, a vibrating body vibrating in the lateral direction, and a pair of elastic members. FIG. 6 is a sectional plan view of part of the vibration motor of Chinese Unexamined Patent Application Publication No. 105518983. In FIG. 6, the lateral direction is represented as the X direction, and the longitudinal direction is represented as the Y direction. A coil member 50 is secured to a base plate included in the casing. Dampers 51 and 52 are secured to respective sides of the coil member 50 in the lateral direction. A vibrating body 53 includes first magnets 531A and 531B, second magnets 532A and 532B, third magnets 533A and 533B, back yokes 534A and 534B, and weights 535A and 535B.

A set of the first magnet 531A, the second magnet 532A, and the third magnet 533A is disposed on one side in the longitudinal direction. The third magnet 533A is interposed between the first magnet 531A and the second magnet 532A disposed in the lateral direction. The first magnet 531A has a south pole on the one side in the lateral direction and a north pole on the other side in the lateral direction. The second magnet 532A has a north pole on the one side in the lateral direction and a south pole on the other side in the lateral direction. The third magnet 533A has a south pole on the one side in the longitudinal direction and a north pole on the other side in the longitudinal direction.

Likewise, a set of the first magnet 531B, the second magnet 532B, and the third magnet 533B are disposed on the other side in the longitudinal direction. The third magnet 533B is interposed between the first magnet 531B and the second magnet 532B in the lateral direction. The first magnet 531B has a south pole on the one side in the lateral direction and a north pole on the other side in the lateral direction. The second magnet 532B has a north pole on the one side in the lateral direction and a south pole on the other side in the lateral direction. The third magnet 533B has a north pole on the one side in the longitudinal direction and a south pole on the other side in the longitudinal direction.

The weights 535A and 535B are disposed such that the above-described two sets each including three magnets arranged in the lateral direction are interposed between the weights 535A and 535B in the lateral direction. The back yoke 534A is disposed between the weight 535A and the first magnets 531A and 531B. The back yoke 534B is disposed between the weight 535B and the second magnets 532A and 532B.

As described above, a so-called Halbach array structure is made by the first magnet 531A, the second magnet 532A, the third magnet 533A, and the back yokes 534A and 534B, thereby magnetic paths that concentrate magnetic fluxes onto the coil member 50 side are formed. This is similarly applicable to the first magnet 531B, the second magnet 532B, the third magnet 533B, and the back yokes 534A and 534B.

Elastic members 54 and 55 are respectively secured to end portions of the vibrating body 53 on the one side and the other side in the lateral direction. The elastic members 54 and 55 are secured to a cover included in the casing. Thus, the vibrating body 53 is supported by the elastic members 54 and 55 such that the vibrating body 53 can vibrate in the lateral direction.

In the vibration motor of the Chinese Unexamined Patent Application Publication No. 105518983, a state of the coil member 50 is switched between a state in which the one side and the other side in the lateral direction are respectively the north pole and the south pole and a state in which the one side and the other side in the lateral direction are respectively the south pole and the north pole by causing a current to flow through the coil member 50.

Here, as illustrated in FIG. 6, when the north pole and the south pole are respectively generated on the one side and the other side of the coil member 50 in the lateral direction, the weight 535A and the back yoke 534A are attracted toward the damper 51 side. When the back yoke 534A approaches the damper 51, the back yoke 534A is quickly attracted to the damper 51 due to loops of the magnetic fluxes indicated by dashed arrows in FIG. 6 and collides with the damper 51. There is a problem in that noise is generated as a sound generated by the collision at this time. Furthermore, also when magnetic poles are generated in the coil member 50 with the opposite polarities to the polarities illustrated in FIG. 6, there is a problem in that noise is generated by a collision of the back yoke 534B with the damper 52.

### SUMMARY OF THE INVENTION

According to an exemplary embodiment of the present invention, a vibration motor includes a stationary portion, a vibrating body, and an elastic member. The stationary portion includes a casing and a coil unit. The vibrating body includes a first weight portion, a second weight portion, and a magnet portion. The vibrating body is supported such that the vibrating body can vibrate in a lateral direction relative to the stationary portion. The elastic member is positioned between the stationary portion and the vibrating body. The first weight portion and the second weight portion are disposed such that the magnet portion is interposed between the first weight portion and the second weight portion in the lateral direction. The magnet portion includes a first magnet, a second magnet, and a third magnet. The first magnet and the second magnet have respective magnetic flux directions opposite to each other in the lateral direction. The third magnet is interposed between the first magnet and the second magnet in the lateral direction. The third magnet has a magnetic flux direction in a longitudinal direction perpendicular to the lateral direction. The magnet portion and the coil unit face each other in the longitudinal direction. A coil member included in the coil unit generates a magnetic flux in the lateral direction. The length of magnet portion in the lateral direction is smaller than a spacing between the first weight portion and the second weight portion in the lateral direction. A gap is provided between the first weight portion and the first magnet. A gap is provided between the second weight portion and the second magnet. The length of the coil member in the lateral direction is smaller than the length of the magnet portion in the lateral direction.

According to the exemplary embodiment of the present application, generation of noise can be suppressed in the vibration motor.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is an overall perspective view of a vibration motor according to a first embodiment of the present invention seen from above.

FIG. 2 is a sectional plan view of the vibration motor according to the first embodiment of the present invention (in a stationary state).

FIG. 3 is a sectional plan view of the vibration motor according to the first embodiment of the present invention (displaced most).

FIG. 4 is a sectional plan view of a vibration motor according to a second embodiment of the present invention.

FIG. 5 is a sectional plan view of a vibration motor according to a third embodiment of the present invention.

FIG. 6 is a sectional plan view of part of a vibration motor of Chinese Unexamined Patent Application Publication No. 105518983.

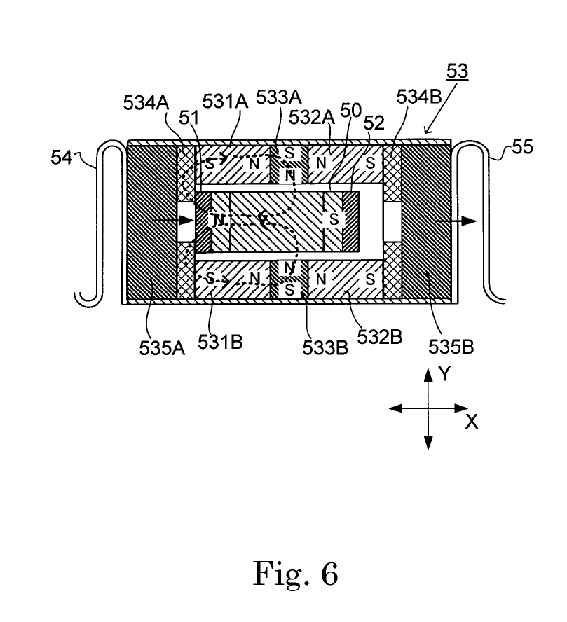

### DETAILED DESCRIPTION OF THE PREFERRED EMBODIMENTS

Exemplary embodiments of the present invention will be described below with reference to the drawings. In the following drawings, a lateral direction in which a vibrating body vibrates is represented as the X direction. Specifically, one side in the lateral direction is represented as the X1 direction, and the other side in the lateral direction is represented as the X2 direction. Furthermore, the longitudinal direction perpendicular to the lateral direction is represented as the Y direction. Specifically, one side in the longitudinal direction is represented as the Y1 direction, and the other side in the longitudinal direction is represented as the Y2 direction. Furthermore, the up-down direction perpendicular to the lateral direction and the longitudinal direction is represented as the Z direction. Specifically, the upper side is represented as the Z1 direction, and the lower side is represented as the Z2 direction. However, it should be understood that these definitions of the directions are not applicable to the positional relationships and the directions when actually assembled in an apparatus.

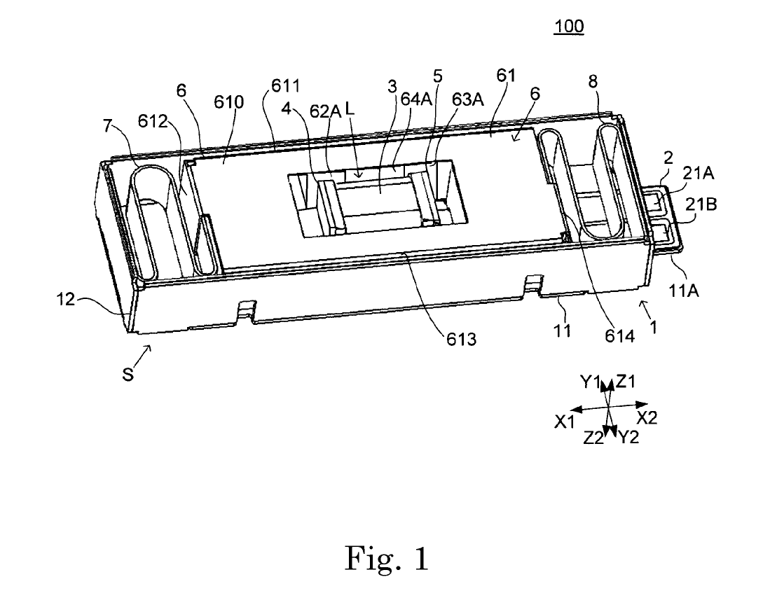

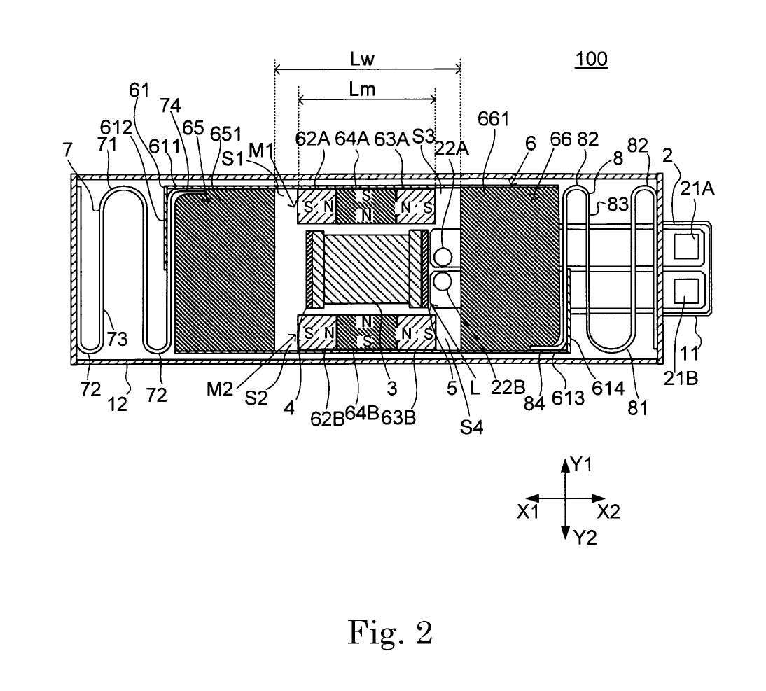

FIG. 1 is an overall perspective view of a vibration motor 100 according to a first embodiment of the present invention seen from above. In FIG. 1, a top surface portion of the cover 12 is omitted so that the structure inside a cover 12 is visible. The inside structure of an actual product is not visible due to the presence of the top surface portion of the cover 12. FIG. 2 is a sectional plan view of the vibration motor 100 in top view taken along a section at the middle in the up-down direction of the cover 12.

Roughly classified, the vibration motor 100 includes a stationary portion S, a vibrating body 6, and a pair of elastic members 7 and 8. The stationary portion S includes a casing 1, a board 2, and a coil unit L.

The casing 1 includes a base plate 11 and the cover 12. The base plate 11 is a plate-shaped member extending in the lateral direction and has a projecting base table portion 11A at an end portion on the other side in the lateral direction. The cover 12 has the top surface portion (not illustrated) and side surface portions extending downward from four sides of the top surface portion. The cover 12 is mounted on the base plate 11 from above. The casing 1 houses therein the board 2, the coil unit L, the vibrating body 6, and the elastic members 7 and 8.

The board 2, which includes a flexible printed circuit board (FPC), is secured to an upper surface of the base plate 11. The board 2 may be a rigid board. The board 2 extends in the lateral direction, and an end portion thereof on the other side in the lateral direction is disposed on the projecting base table portion 11A. Terminals 21A and 21B are provided at this end portion of the board 2.

The coil unit L includes a coil member 3 and damper members 4 and 5. The coil member 3 is structured such that a coil wire is wound around the axis extending in the lateral direction. An iron core extending in the lateral direction is disposed in a space surrounded by the coil wire. With this iron core, the magnetic flux density in the space surrounded by the coil wire can be increased. The coil member 3 is secured to the upper surface of the base plate 11. Leads extending from the coil member 3 are electrically connected to terminals 22A and 22B of the board 2. Electrical conduction is established between the terminal 21A and the terminal 22A and between the terminal 21B and the terminal 22B. Thus, when a voltage is applied from the outside of the vibration motor 100 to the terminals 21A and 21B, a current can be caused to flow through the coil member 3 so as to drive the coil member 3. A state of the coil member 3 is switched between a state in which the north pole and the south pole are respectively generated on the one side and the other side in the lateral direction and a state in which the south pole and the north pole are respectively generated on the one side and the other side in the lateral direction by controlling the current flowing through the coil member 3. That is, the coil member 3 generates a magnetic flux in the lateral direction.

The damper members 4 and 5 are respectively secured to end portions of the coil member 3 on the one side and the other side in the lateral direction.

The vibrating body 6 includes a holding portion 61, a first magnet portion M1, a second magnet portion M2, a first weight portion 65, and a second weight portion 66. The holding portion 61 has a top plate portion 610 and side plate portions 611 to 614 projecting downward from four sides of the top plate portion 610. The side plate portion 611 and the side plate portion 613 extend in the lateral direction face each other in the longitudinal direction. The side plate portion 612 extending in the longitudinal direction is connected to an end portion of the side plate portion 611 on the one side in the lateral direction. The side plate portion 614 extending in the longitudinal direction is connected to an end portion of the side plate portion 613 on the other side in the lateral direction.

The first magnet portion M1 is secured to an inner surface of the side plate portion 611. The second magnet portion M2 is secured to an inner surface of the side plate portion 613. The first weight portion 65 and the second weight portion 66 are respectively secured to the inner surfaces of the side plate portion 611 and the side plate portion 613. Thus, the first magnet portion M1, the second magnet portion M2, the first weight portion 65, and the second weight portion 66 are held by the holding portion 61.

The first magnet portion M1 includes a first magnet 62A, a second magnet 63A, and a third magnet 64A. The third magnet 64A is interposed between the first magnet 62A and the second magnet 63A in the lateral direction.

The first magnet 62A has a south pole on the one side in the lateral direction and a north pole on the other side in the lateral direction. The second magnet 63A has a north pole on the one side in the lateral direction and a south pole on the other side in the lateral direction. That is, the magnetic flux directions of the first magnet 62A and the second magnet 63A are opposite to each other in the lateral direction.

The third magnet 64A has a south pole on the one side in the longitudinal direction and a north pole on the other side in the longitudinal direction. That is, the magnetic flux direction of the third magnet 64A is in the longitudinal direction.

The first magnet portion M1 and the coil unit L face each other in the longitudinal direction. With the magnetic poles of the first magnet portion M1 disposed as described above, a so-called Halbach array structure is made. Thus, magnetic paths that concentrate the magnetic fluxes onto the coil unit L side can be formed.

The second magnet portion M2 faces the first magnet portion M1 in the longitudinal direction with the coil unit L interposed therebetween. The second magnet portion M2 includes a first magnet 62B, a second magnet 63B, and a third magnet 64B. The third magnet 64B is interposed between the first magnet 62B and the second magnet 63B in the lateral direction.

The first magnet 62B has a south pole on the one side in the lateral direction and a north pole on the other side in the lateral direction. The second magnet 63B has a north pole on the one side in the lateral direction and a south pole on the other side in the lateral direction. That is, the magnetic flux directions of the first magnet 62B and the second magnet 63B are opposite to each other in the lateral direction.

The third magnet 64B has a north pole on the one side in the longitudinal direction and a south pole on the other side in the longitudinal direction. That is, the magnetic flux direction of the third magnet 64B is in the longitudinal direction.

The second magnet portion M2 and the coil unit L face each other in the longitudinal direction. With the magnetic poles of the second magnet portion M2 disposed as described above, a Halbach array structure is made. Thus, magnetic paths that concentrate the magnetic fluxes onto the coil unit L side can be formed.

Alternatively, a structure provided with only one of the first magnet portion M1 and the second magnet portion M2 may be used.

The first weight portion 65 includes a first weight member 651. According to the present embodiment, the first weight portion 65 does not include a member other than the first weight member 651. The second weight portion 66 includes a second weight member 661. According to the present embodiment, the second weight portion 66 does not include a member other than the second weight member 661.

The first weight portion 65 and the second weight portion 66 are disposed such that the first magnet portion M1 and the second magnet portion M2 are interposed between the first weight portion 65 and the second weight portion 66 in the lateral direction. A length Lm of the first magnet portion M1 and the second magnet portion M2 in the lateral direction is smaller than a spacing Lw between the first weight portion 65 and the second weight portion 66 in the lateral direction. A gap S1 is provided between the first weight portion 65 and the first magnet portion M1, and a gap S2 is provided between the first weight portion 65 and the second magnet portion M2. A gap S3 is provided between the second weight portion 66 and the first magnet portion M1, and a gap S4 is provided between the second weight portion 66 and the second magnet portion M2. Furthermore, the length of the coil member 3 in the lateral direction is smaller than the length Lm of the first magnet portion M1 and the second magnet portion M2 in the lateral direction.

The elastic member 7 is a plate spring member having a first bent portion 71, second bent portions 72, four flat plate portions 73, and a securing portion 74. Two of the second bent portions 72 are provided. The first bent portion 71 is bent toward the one side in the longitudinal direction. The second bent portions 72 are bent toward the other side in the longitudinal direction. Each of the flat plate portions 73 does not have a curved portion and extends in the longitudinal direction when the vibrating body 6 is in a stationary state. The stationary state of the vibrating body 6 means a non-operating state in which no power is supplied to the coil member 3 and the vibrating body 6 does not vibrate. Ends of the first bent portion 71 and the second bent portions 72 are connected to the flat plate portions 73. The first bent portion 71 and the second bent portions 72 are connected by the flat plate portions 73 in an alternating sequence.

The securing portion 74 is curved and extends in the lateral direction from one of a plurality of flat plate portions 73 disposed, in the lateral direction, at an end on the other side of the elastic member 7. The securing portion 74 is secured to the inner surface of the side plate portion 611 of the holding portion 61. The flat plate portion 73 disposed, in the lateral direction, at the end on the other side of the elastic member 7 is secured to the inner surface of the side plate portion 612. Thus, one end portion of the elastic member 7 is secured to the vibrating body 6. One of the flat plate portions 73 disposed, in the lateral direction, at an end on the one side of the elastic member 7 is secured to the inner surface of the cover 12. Thus, the other end portion of the elastic member 7 is secured to the casing 1.

The elastic member 8 is a plate spring member having a first bent portion 81, second bent portions 82, four flat plate portions 83, and a securing portion 84. Two of the second bent portions 82 are provided. The first bent portion 81 is bent toward the other side in the longitudinal direction. The second bent portions 82 are bent toward the one side in the longitudinal direction. Each of the flat plate portions 83 does not have a curved portion and extends in the longitudinal direction when the vibrating body 6 is in a stationary state. Ends of the first bent portion 81 and the second bent portions 82 are connected to the flat plate portions 83. The first bent portion 81 and the second bent portions 82 are connected by the flat plate portions 83 in an alternating sequence.

The securing portion 84 is curved and extends in the lateral direction from one of a plurality of flat plate portions 83 disposed, in the lateral direction, at an end on the one side of the elastic member 8. The securing portion 84 is secured to the inner surface of the side plate portion 613 of the holding portion 61. The flat plate portion 83 disposed, in the lateral direction, at the end on the one side of the elastic member 8 is secured to the inner surface of the side plate portion 614. Thus, one end portion of the elastic member 8 is secured to the vibrating body 6. One of the flat plate portions 83 disposed, in the lateral direction, at an end on the other side of the elastic member 8 is secured to the inner surface of the cover 12. Thus, the other end portion of the elastic member 8 is secured to the casing 1.

Thus, the vibrating body 6 is supported by the elastic members 7 and 8 such that the vibrating body 6 can vibrate in the lateral direction relative to the casing 1.

Next, operation of the vibration motor 100 having a structure as described above is described. In the state illustrated in FIG. 2, no power is supplied to the coil member 3 and the vibrating body 6 is at rest. From this state, when control for causing the poles generated in the coil member 3 to switch is performed by controlling power supply, the vibrating body 6 can vibrate in the lateral direction.

During vibration of the vibrating body 6, when the north pole is generated at an end of the coil member 3 on the one side in the lateral direction while the south poles of the first magnets 62A and 62B are at positioned shifted to the one side in the lateral direction from the end of the coil member 3 on the one side in the lateral direction, mutual attraction between the north pole of the coil member 3 and the south poles of the first magnets 62A and 62B causes a force to act on the vibrating body 6. This force is directed toward the other side in the lateral direction. Thus, the vibrating body 6 is moved in a direction in which the first weight portion 65 approaches the damper member 4.

With the gaps S1 and S2 provided, before the first weight portion 65 is brought into contact with the damper member 4 due to the movement of the vibrating body 6, the south poles of the first magnets 62A and 62B can be positioned further to the other side in the lateral direction than the north pole of the coil member 3 at the end on the one side in the lateral direction. In this state, mutual attraction between the north pole of the coil member 3 and the south poles of the first magnets 62A and 62B causes a force to act on the vibrating body 6. This force is directed toward the one side in the lateral direction, that is, in the opposite direction to the moving direction.

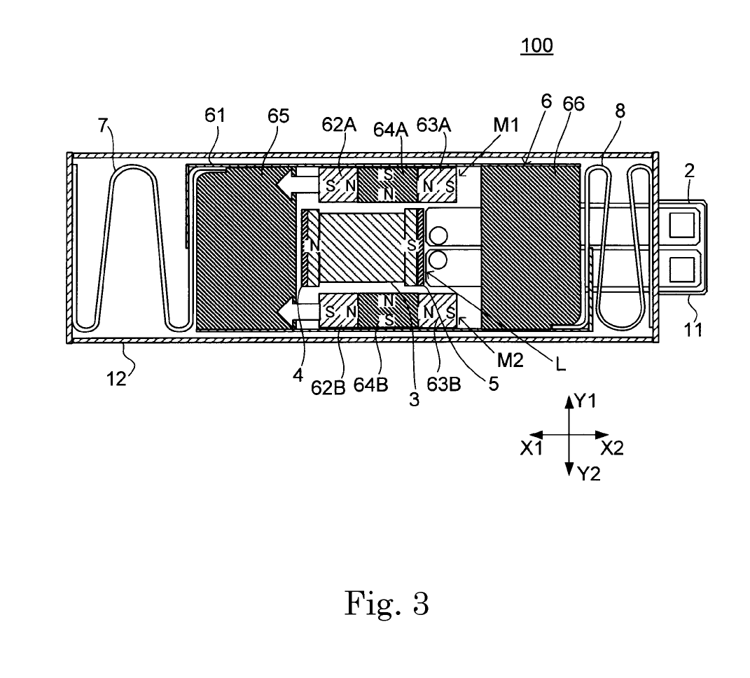

Thus, the vibrating body 6 is decelerated, and accordingly, the vibrating body 6 can be stopped before the first weight portion 65 is brought into contact with the damper member 4 as illustrated in FIG. 3. Hollow arrows illustrated FIG. 3 indicate the force directed toward the one side in the lateral direction acting on the vibrating body 6. That is, due to a magnetic damping effect, the first weight portion 65 is not brought into contact with the damper member 4 when the vibrating body 6 is displaced most. This can suppress generation of noise as a sound generated by a collision between the first weight portion 65 and the damper member 4.

Furthermore, as is the case with the above-described case, when the north pole is generated at the end of the coil member 3 on the other side in the lateral direction, mutual attraction between the north pole of the coil member 3 and the south poles of the second magnets 63A and 63B causes a force to act on the vibrating body 6 moving toward the one side in the lateral direction. This force is directed toward the other side in the lateral direction, that is, in the opposite direction to the moving direction. Due to such a magnetic damping effect, the vibrating body 6 can be stopped before the second weight portion 66 is brought into contact with the damper member 5. Accordingly, the second weight portion 66 is not brought into contact with the damper member 5 when the vibrating body 6 is displaced most. This can suppress generation of noise due to a collision between the second weight portion 66 and the damper member 5.

As has been described, the vibration motor 100 according to the present embodiment includes the stationary portion S, the vibrating body 6, and the elastic members 7 and 8. The stationary portion S includes the casing 1 and the coil unit L. The vibrating body 6 includes the first weight portion 65, the second weight portion 66, and the magnet portions M1 and M2. The vibrating body 6 is supported such that the vibrating body 6 can vibrate in the lateral direction relative to the stationary portion S. The elastic members 7 and 8 are positioned between the stationary portion S and the vibrating body 6.

The first weight portion 65 and the second weight portion 66 are disposed such that the magnet portions M1 and M2 are interposed between the first weight portion 65 and the second weight portion 66 in the lateral direction. The magnet portion M1 includes the first magnet 62A, the second magnet 63A, and the third magnet 64A. The magnet portion M2 includes the first magnet 62B, the second magnet 63B, and the third magnet 64B. The first magnets 62A and 62B have the magnetic flux directions opposite to those of the second magnets 63A and 63B in the lateral direction, respectively. The third magnet 64A is interposed between the first magnet 62A and the second magnet 63A in the lateral direction. The third magnet 64B is interposed between the first magnet 62B and the second magnet 63B in the lateral direction. The third magnets 64A and 64B have the magnetic flux directions in the longitudinal direction perpendicular to the lateral direction.

The magnet portions M1 and M2 face the coil unit L in the longitudinal direction. The coil member 3 included in the coil unit L generates a magnetic flux in the lateral direction. The length Lm of the magnet portions M1 and M2 in the lateral direction is smaller than the spacing Lw between the first weight portion 65 and the second weight portion 66 in the lateral direction. The gaps S1 and S2 are provided between the first weight portion 65 and the first magnets 62A and 62B, and the gaps S3 and S4 are provided between the second weight portion 66 and the second magnets 63A and 63B. The length of the coil member 3 in the lateral direction is smaller than the length Lm of the first magnet portion M1 and the second magnet portion M2 in the lateral direction.

Such a structure allows the drawing force to act on the vibrating body 6 from the coil member 3 so as to draw back the vibrating body 6 in the opposite direction to the moving direction of the vibrating body 6 during vibration of the vibrating body 6. Thus, due to the magnetic damping effect, the vibrating body 6 can be stopped before the first weight portion 65 or the second weight portion 66 is brought into contact with the coil unit L. That is, collision of the weight portion 65 or 66 with the coil unit L when the vibrating body 6 is displaced most can be avoided, thereby generation of noise due to the sound caused by collision can be suppressed.

Furthermore, according to the present embodiment, each of the first weight portion 65 and the second weight portion 66 includes a corresponding one of the weight members 651 and 661, and neither the first weight portion 65 nor the second weight portion 66 includes a member in a region thereof closer to the magnet portion M1 or M2 side than the weight member 651 or 661.

This increases movable ranges of the first weight portion 65 and the second weight portion 66, and accordingly, collision of the first weight portion 65 or the second weight portion 66 with the coil unit L can be further suppressed.

Furthermore, according to the present embodiment, the coil unit L includes the damper members 4 and 5 disposed, in the lateral direction, further to outer sides than end portions of the coil member 3. With the damper member 4 or 5, even when the first weight portion 65 or the second weight portion 66 is excessively moved in the case of, for example, dropping of the vibration motor 100, the weight portion 65 or 66 is brought into contact with the damper member 4 or 5. Thus, excessive deformation of the elastic member 7 or 8 can be suppressed. During normal operations, due to the above-described magnetic damping effect, collision of the weight portions 65 and 66 with the damper members 4 and 5 can be suppressed.

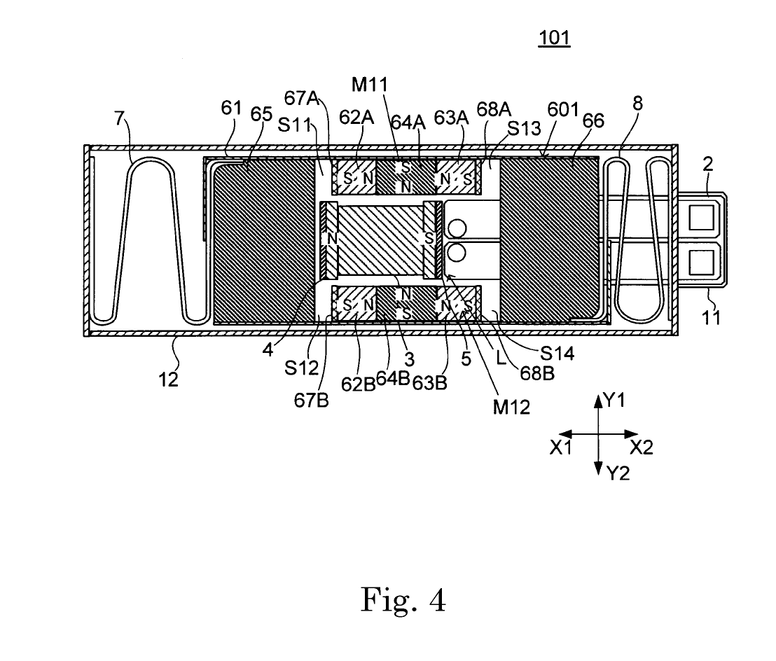

Next, a second embodiment of the present invention as a modification of the above-described first embodiment is described. FIG. 4 is a sectional plan view of the structure of a vibration motor 101 according to the second embodiment of the present invention. FIG. 4 corresponds to FIG. 2 of the first embodiment.

Here, the difference between the first embodiment and the second embodiment is mainly described. The vibration motor 101 includes a vibrating body 601. The vibrating body 601 includes a first magnet portion M11, a second magnet portion M12, the first weight portion 65, and the second weight portion 66.

The first magnet portion M11 includes the first magnet 62A, the second magnet 63A, the third magnet 64A, a back yoke 67A, and a back yoke 68A. The structures of the first magnet 62A, the second magnet 63A, and the third magnet 64A are the same as or similar to those of the first embodiment. The back yoke 67A is secured to an end of the first magnet 62A on the one side in the lateral direction, and the back yoke 68A is secured to an end of the second magnet 63A on the other side in the lateral direction. The back yokes 67A and 68A include magnetic bodies.

The length of the first magnet portion M11 in the lateral direction is smaller than the spacing between the first weight portion 65 and the second weight portion 66. A gap S11 is provided between the back yoke 67A and the first weight portion 65, and a gap S13 is provided between the back yoke 68A and the second weight portion 66.

The second magnet portion M12 includes the first magnet 62B, the second magnet 63B, the third magnet 64B, a back yoke 67B, and a back yoke 68B. The structures of the first magnet 62B, the second magnet 63B, and the third magnet 64B are the same as or similar to those of the first embodiment. The back yoke 67B is secured to an end of the first magnet 62B on the one side in the lateral direction, and the back yoke 68B is secured to an end of the second magnet 63B on the other side in the lateral direction. The back yokes 67B and 68B include magnetic bodies.

The length of the second magnet portion M12 in the lateral direction is smaller than the spacing between the first weight portion 65 and the second weight portion 66 in the lateral direction. A gap S12 is provided between the back yoke 67B and the first weight portion 65, and a gap S14 is provided between the back yoke 68B and the second weight portion 66.

In the vibration motor 101 having the structure as described above, when, for example, a north pole is generated on the one side of the coil member 3 in the lateral direction, the vibrating body 601 is moved toward the other side in the lateral direction. At this time, with the gaps S11 and S12 provided, before the first weight portion 65 is brought into contact with the damper member 4, the back yokes 67A and 67B can be located at positions shifted further to the other side in the lateral direction than the north pole of the coil member 3 at the end on the one side in the lateral direction. Consequently, mutual attraction between the north pole of the coil member 3 and the back yokes 67A and 67B causes a force to act on the vibrating body 601. This force is directed toward the one side in the lateral direction, that is, in the opposite direction to the moving direction. Thus, the vibrating body 601 is decelerated due to the magnetic damping effect, and accordingly, the vibrating body 601 can be stopped before the first weight portion 65 is brought into contact with the damper member 4. That is, as illustrated in FIG. 4, contact between the first weight portion 65 and the damper member 4 when the vibrating body 601 is displaced most can be avoided. This can suppress generation of noise caused by a collision.

Furthermore, also when the north pole is generated on the other side of the coil member 3 in the lateral direction, mutual attraction between the north pole of the coil member 3 and the back yokes 68A and 68B causes a drawing force toward the other side in the lateral direction to act on the vibrating body 601 during the movement of the vibrating body 601 toward the one side in the lateral direction. Thus, the vibrating body 601 can be stopped before the second weight portion 66 is brought into contact with the damper member 5. That is, contact between the second weight portion 66 and the damper member 5 when the vibrating body 601 is displaced most can be avoided, thereby generation of noise due to collision can be suppressed.

As has been described, in the vibration motor 101 according to the present embodiment, the magnet portions M11 and M12 further include the back yokes 67A, 67B, 68A, and 68B disposed at outer sides of the first magnets 62A and 62B and the second magnets 63A and 63B in the lateral direction.

This allows a larger drawing force to act on the vibrating body 601 so as to draw back in the opposite direction to the moving direction. Accordingly, collision of the first weight portion 65 or the second weight portion 66 with the coil unit L can be effectively suppressed.

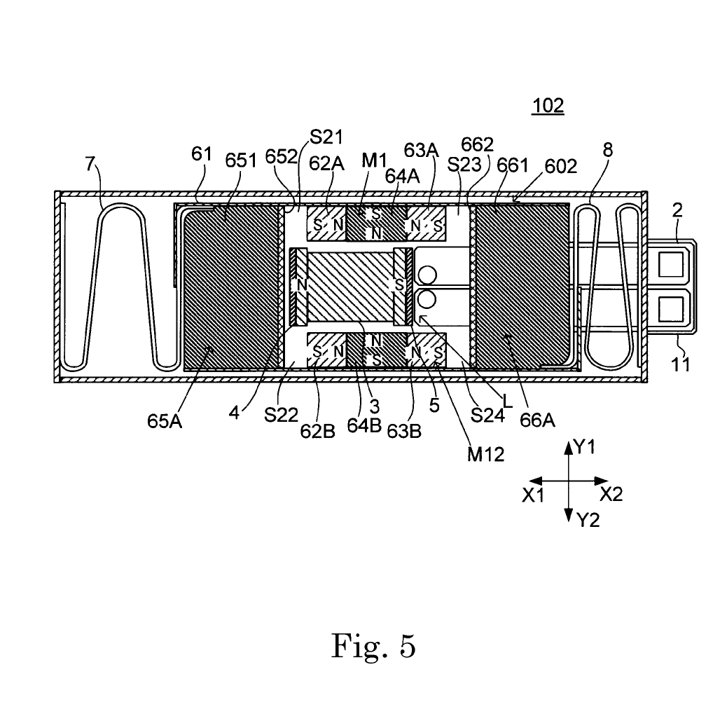

Next, a third embodiment as another modification of the above-described first embodiment is described. FIG. 5 is a sectional plan view of the structure of a vibration motor 102 according to the third embodiment of the present invention. FIG. 5 corresponds to FIG. 2 of the first embodiment.

Here, the difference between the first embodiment and the third embodiment is mainly described. The vibration motor 102 includes a vibrating body 602. The vibrating body 602 includes the first magnet portion M1, the second magnet portion M2, a first weight portion 65A, and a second weight portion 66A.

According to the present embodiment, the first weight portion 65A includes a back yoke 652 in addition to the first weight member 651. The back yoke 652 has a magnetic body and is secured to an end of the first weight member 651 on the other side in the lateral direction. Furthermore, the second weight portion 66A includes a back yoke 662 in addition to the second weight member 661. The back yoke 662 has a magnetic body and is secured to an end of the second weight member 661 on the one side in the lateral direction.

The length of the first magnet portion M1 in the lateral direction is smaller than the spacing between the first weight portion 65A and the second weight portion 66A. Gaps S21 and S22 are provided between the back yoke 652 and the first magnets 62A and 62B, and gaps S23 and S24 are provided between the back yoke 662 and the second magnets 63A and 63B.

In the vibration motor 102 having the structure as described above, when, for example, a north pole is generated on the one side of the coil member 3 in the lateral direction, the vibrating body 602 is moved toward the other side in the lateral direction. At this time, with the gaps S21 and S22 provided, before the back yoke 652 is brought into contact with the damper member 4, the first magnets 62A and 62B can be located at positions shifted further to the other side in the lateral direction than the north pole of the coil member 3 at the end on the one side in the lateral direction. Consequently, mutual attraction between the north pole of the coil member 3 and the first magnets 62A and 62B causes a force to act on the vibrating body 602. This force is directed toward the one side in the lateral direction, that is, in the opposite direction to the moving direction. Thus, the vibrating body 602 is decelerated due to the magnetic damping effect, and accordingly, the vibrating body 602 can be stopped before the back yoke 652 is brought into contact with the damper member 4. That is, as illustrated in FIG. 5, contact between the back yoke 652 and the damper member 4 when the vibrating body 602 is displaced most can be avoided. This can suppress generation of noise caused by a collision.

Furthermore, also when the north pole is generated on the other side of the coil member 3 in the lateral direction, mutual attraction between the north pole of the coil member 3 and the second magnets 63A and 63B causes a drawing force toward the other side in the lateral direction to act on the vibrating body 602 during the movement of the vibrating body 602 toward the one side in the lateral direction. Thus, the vibrating body 602 can be stopped before the back yoke 662 is brought into contact with the damper member 5. That is, contact between the back yoke 662 and the damper member 5 when the vibrating body 602 is displaced most can be avoided. This can suppress generation of noise caused by a collision.

As has been described, in the vibration motor 102 according to the present embodiment, the first weight portion 65A and the second weight portion 66A include the respective weight members 651 and 661 and the respective back yokes 652 and 662 disposed closer to the magnet portions M1 and M2 side than the weight members 651 and 661.

This can increase the drawing force for drawing the first weight portion 65A or the second weight portion 66A toward the coil unit L side. Thus, collision of the first weight portion 65A or the second weight portion 66A with the coil unit L can be effectively suppressed due to the magnetic damping effect.

Although the embodiments of the present invention have been described, the embodiments can be varied in various manners without departing from the spirit of the present invention.

For example, the damper member 4 or 5 is not necessarily provided in the coil unit L. Furthermore, the form of the elastic member 7 or 8 is not necessarily limited to the plate spring member as has been described. The elastic members 7 and 8 may include coil springs.

The present invention can be utilized for vibration motors provided in, for example, smartphones, gamepads, and so forth.

Features of the above-described preferred embodiments and the modifications thereof may be combined appropriately as long as no conflict arises.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A vibration motor comprising:
a stationary portion including
a casing, and
a coil unit, the coil unit including
a coil member configured to generate a magnetic flux in a lateral direction;
a vibrating body supported such that the vibrating body is able to vibrate in the lateral direction relative to the stationary portion, the vibrating body including
a magnet portion facing the coil unit in a longitudinal direction perpendicular to the lateral direction, the magnet portion having such a length in the lateral direction that a length of the coil member in the lateral direction is smaller than the length of the magnet portion in the lateral direction, the magnet portion including
a first magnet and a second magnet having respective magnetic flux directions opposite to each other in the lateral direction, and
a third magnet interposed between the first magnet and the second magnet in the lateral direction, the third magnet having a magnetic flux direction in the longitudinal direction, and
a first weight portion and a second weight portion disposed such that the magnet portion is interposed between the first weight portion and the second weight portion in the lateral direction, the first weight portion and the second weight portion being spaced apart from each other in the lateral direction with such a spacing therebetween that the length of the magnet portion in the lateral direction is smaller than the spacing between the first weight portion and the second weight portion in the lateral direction, the first weight portion being spaced apart from the first magnet with a gap therebetween, the second weight portion being spaced apart from the second magnet with a gap therebetween; and
an elastic member positioned between the stationary portion and the vibrating body.

2. The vibration motor according to claim 1,
wherein each of the first weight portion and the second weight portion includes a corresponding one of weight members, and
neither the first weight portion nor the second weight portion includes a member in a region thereof closer to a magnet portion side than the weight member.

3. The vibration motor according to claim 1,
wherein the magnet portion further includes
back yokes disposed at outer sides of the first magnet and the second magnet in the lateral direction.

4. The vibration motor according to claim 1,
wherein each of the first weight portion and the second weight portion includes
a corresponding one of weight members, and
a corresponding one of back yokes disposed closer to a magnet portion side than the weight member.

5. The vibration motor according to claim 1,
wherein the coil unit includes
damper members disposed, in the lateral direction, further to outer sides than end portions of the coil member.

6. The vibration motor according to claim 3,
wherein the coil unit includes
damper members disposed, in the lateral direction, further to outer sides than end portions of the coil member.

7. The vibration motor according to claim 4,
wherein the coil unit includes
damper members disposed, in the lateral direction, further to outer sides than end portions of the coil member.
